(19) United States
(12) Patent Application Publication
(10) Pub. No.: US 2016/0280420 A1
(43) Pub. Date: Sep. 29, 2016

(54) DEVICE FOR PROVIDING INFORMATION ABOUT THE PHYSICAL CHARACTERISTICS OF A PERSON'S SURROUNDINGS

(71) Applicant: NETUX SAS, Medellin (CO)

(72) Inventors: Juan Pablo VELASQUEZ POSADA, Medellín (CO); Sergio COCK RAMIREZ, Medellín (CO); Sergio Albeiro MARIN CORREA, Medellín (CO); Jorge Eduardo CARDONA GAVIRIA, Medellín (CO)

(73) Assignee: NETUX SAS, Medellin (CO)

(21) Appl. No.: 14/911,074

(22) PCT Filed: Aug. 9, 2014
(86) PCT No.: PCT/IB2014/063812

§ 371 Date: May 16, 2016

(30) Foreign Application Priority Data
Aug. 9, 2013 (CO) 13-188956

(51) Int. Cl. B65D 25/00; H04Q 9/00

(52) U.S. Cl. CPC B65D 25/00; H04Q 9/00; H04Q 2209/43

(57) ABSTRACT

The present invention describes a container for drinking liquids, equipped with electronic elements, which enable it to monitor the physical and chemical characteristics of the liquid to be drunk, the movement of the container that holds said liquid, and also transmits the information related to the use of said container. Further advantages of the invention are described in the summary of the invention.

Regarding the field of the invention, the present invention is generally related to containers for drinking liquids, and is specifically related to containers for drinking liquids equipped with electronic elements, which enable it to monitor the physical and chemical characteristics of the liquid to be drunk, the movement of the container that holds said liquid, and also transmits the information related to the use of said container.

### FIELD OF THE INVENTION

The present invention relates to devices that provide information about their environment by means of electronic systems.

### PRIOR ART

Containers with electronic elements for drinking liquids, primarily geared toward temperature control, which contain a sensor element functionally connected to a controller that sends signals to an electric resistance to heat said liquid, preventing it from cooling, have been described in prior art.

For example, U.S. Pat. No. 7,022,946B2 discloses an electronic container equipped with a temperature sensor that communicates with a heating element to keep a liquid hot, and a user interface attached to the upper portion of the container to input the desired temperature value.

US patent 2010/0187298A1 discloses a container that contains an insertable electronic card that detects the liquid fill level and performs the collection process when a beverage is served in said recipient. Said device does not disclose the monitoring of chemical variables in the liquid, and does not aim to explain how said data is transmitted to external devices.

Accordingly, there is a need for the monitoring of chemical and physical characteristics of a liquid inside a container before ingestion, features that have not been disclosed in prior art. There is an equal need to provide a device that enables description of the mode of consumption in terms of the container's movement at the moment of drinking, and that also allows for transmission of information to external devices by means of wires and wirelessly.

### BRIEF DESCRIPTION OF THE INVENTION

The present invention discloses a device that provides information about the physical characteristics of its environment, which is characterized by containing an electronic system consisting of a plurality of sensors that measure at least one physical and/or chemical variable in the physical environment of the device, a data processing system that processes the data collected by the plurality of sensors, and a communication system that transmits the processed information from the sensors to a data center where the physical variables are determined.

### FIGURE DESCRIPTIONS

FIG. 1 shows a frontal view of one embodiment of the container of the present invention with the electronic components that measure physical variables. It shows a sensor element and an embedded electronic device linked to said sensor.

FIG. 2 shows a lateral view of one embodiment of the container of the present invention with the electronic components that measure the physical variables of a liquid beverage in a container. It shows a power-supply module, the sensor element, and the data processing and communication module.

FIG. 3 shows a top and bottom view of one embodiment of the present invention, which shows a container with all of the electronic components that measure the physical variables of a liquid.

### DETAILED DESCRIPTION OF THE INVENTION

The present invention, based on its most relevant features, discloses a device that provides information about the physical characteristics of its environment, which is characterized by containing an electronic system consisting of a plurality of sensors that measure at least one physical and/or chemical variable in the physical environment of the device, a data processing system that processes the data collected by the plurality of sensors, and a communication system that transmits the processed information from the sensors to a data center for determination of the physical variables.

In preferred embodiments, the present invention discloses a container that holds drinkable liquids, which incorporates electronic systems that are in direct contact with the liquid, for the purpose of monitoring, identifying and transmitting the signals detected by a plurality of sensors that measure multiple physical and chemical variables, such as temperature, fill level, the density of the liquid in the container, the color of the liquid, the chemical composition of the liquid, etc. Furthermore, in preferred embodiments, the present invention contains electronic means that allow for detection of the movement caused by drinking said liquid.

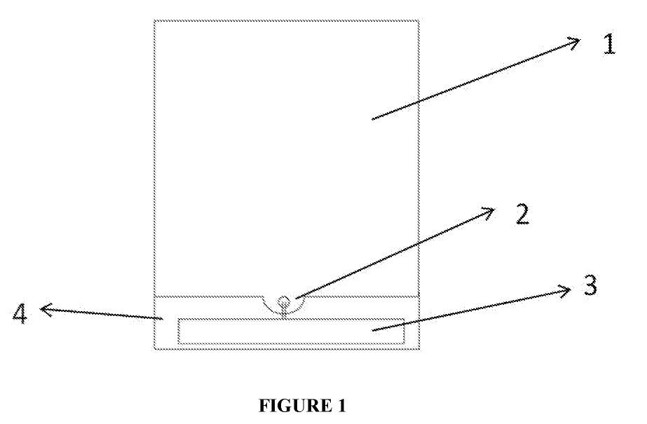

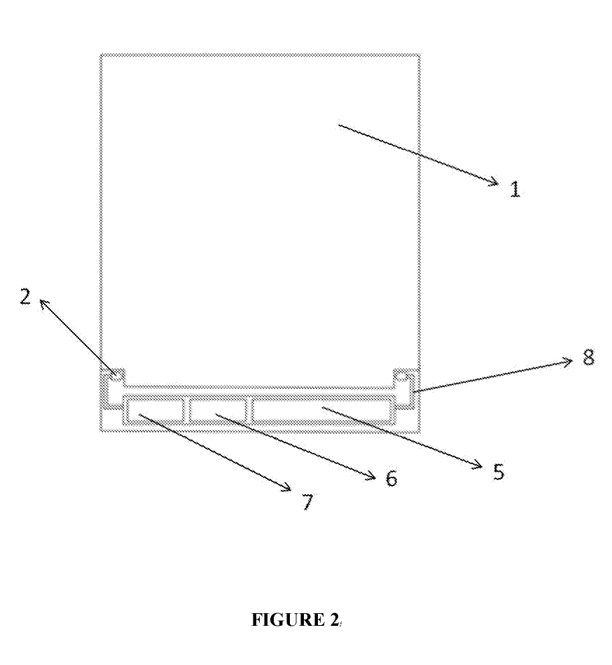

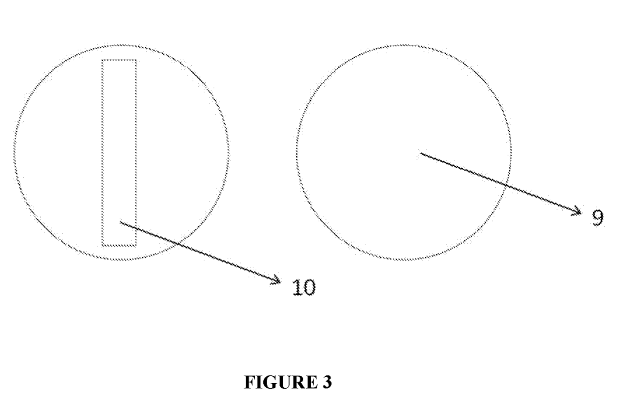

To enable understanding of the present invention, the preferred embodiments shown in FIGS. 1, 2 and 3 are described. These show a container that contains electronic systems that are structurally able to be implemented in areas where they do not interfere with the normal use of a container to drink liquids. The plurality of sensors that measure the physical and chemical characteristics of the device allow for the monitoring of characteristics specific to liquids for human consumption, specifically, the sensors of the device of the present invention are geared toward monitoring the physical and chemical characteristics of the liquid, as well as the characteristics related to the process of drinking said liquid.

Readings for these properties are obtained by employing a plurality of sensors that measure physical and chemical variables. In preferred embodiments, the plurality of sensors is composed of the group of sensors for: chemical substances, position, trajectory, velocity, acceleration, temperature, color, density, fill level and hydrostatic pressure.

Furthermore, the electronic system of the device of the present invention allows for the transmission of information collected by the sensors connected to a plurality of external devices that analyze the recorded variables. The following elements are present in the device of the present invention, referencing the Figures:
A container (1) that can be filled with liquids, that has an exterior surface, as shown in FIG. 1, as a specific embodiment of the present invention;
At least one sensor for physical and/or chemical substances (2) to detect their presence in the liquid in said container (1);
At least one embedded electronic system (5), that is connected to a plurality of sensors (6, 8), to quantify and transmit the concentrations of the chemical substances present in said liquid;
In a preferred embodiment of the present invention, the device possesses at least one motion sensor to measure the position, trajectory, velocity, and acceleration of said container, for the purpose of processing and transmitting the position, trajectory, velocity, and acceleration of said container. The sensor (2) can be placed at the center of the bottom of the container to ensure contact between the sensor and the liquid;
In another embodiment of the present invention, the device possesses at least one temperature sensor to measure the temperature of the liquid in said container. The sensor (2) can be placed at the center of the bottom of the container to ensure contact between the sensor and the liquid;
In another embodiment of the present invention, the device possesses at least one color sensor to detect the color characteristics of the liquid in said container. The sensor (2) can be placed at the center of the bottom of the container to ensure contact between the sensor and the liquid;
In another embodiment of the present invention, the device possesses at least one density sensor, in order to find the volume of liquid, with prior knowledge of the mass in the container, without the need to measure it with an additional instrument. It also allows for characterization of the liquid in the container for some applications that require this variable to be set in order to estimate concentrations of sugars and other solutes, for example. The sensor (2) can be placed at the center of the bottom of the container to ensure contact between the sensor and the liquid;
In another embodiment of the present invention, the device possesses at least one fill level sensor to detect the volume of the liquid in said container. The sensor (2) can be placed at the center of the bottom of the container to ensure contact between the sensor and the liquid;
In another embodiment of the present invention, the device possesses at least one pressure sensor to measure the hydrostatic pressure of the liquid in said container. The sensor (2) can be placed at the center of the bottom of the container to ensure contact between the sensor and the liquid;
In another embodiment of the present invention, the device possesses at least one signal transmitter linked to said embedded electronic devices (2) (3), for the purpose of exporting the information obtained by the sensors placed in said container;
In another embodiment of the present invention, the device possesses an interface attached to the exterior surface of said container (1) and linked to the controllers (3) for presenting the information obtained by the sensors placed in said container (1) in graphical form.
   In a preferred version of the invention, the electronic system (3) is located in the bottom part of the container (4), so that the respective sensor (2) is the only element in direct contact with the liquid

For the purposes of the present invention, a container (2) is an item with any geometry that can contain liquids. In preferred embodiments, the geometry is preferably concave, such as a cup, a bowl, a mug or similar elements that serve the same function.

For the purposes of the present invention, an embedded electronic device (3) is a device composed of hardware and software specifically designed and optimized to solve a specific problem in an efficient way. The term “embedded” refers to an electronic module housed by a larger system, that helps said system perform operations, such as processing data from the sensors, control of electric drives, information analysis, among others.

Accordingly, the electronic system of the present invention is composed of a sensor element that receives a physical or chemical signal and converts it to an electric signal; a microcontroller that contains at least: an ADC module (Convertidor Análogo/Digital in Spanish), a UART serial communication module (Transmisor-Receptor Asincrono Universal in Spanish), an I2C communication module, to read the information transmitted by the sensor; a power-management element that supplies power to all of the elements of the system; and a wireless communication module that sends information to a platform hosted on a web server.

In another aspect of the present invention, the electronic container (1) also contains the means to provide electric power to the embedded electronic devices, the transmitters and the attached interface (7).

In a preferred version of the invention, the electronic, processing and communication systems are connected to an electric power supply, which can be an energy accumulator selected from the group that consists of: batteries, wireless charging devices understood to mean inductive charging devices, piezoelectric devices, or energy-harvesting devices, making use of renewable sources of energy such as sunlight.

For the purposes of the present invention, the embedded electronic system contains a central processing or microcontroller unit, a power-management module, the sensor elements and data transmitter-receiver or transceiver.

In a preferred version of the present invention, signal transmission is performed by means of wireless communication, using a communication protocol selected from the group that consists of: IEEE 802.15.4, Zigbee, 6LowPan, Bluetooth, wifi, cellular network, Ant+. In other versions, said means of communication can also be wired, in which case the protocol used is selected from the group that consists mainly of: USB and stereo plug. Other similar protocols can also be incorporated in the present invention to facilitate the process of communicating the signals obtained by the sensors in the container.

In another aspect of the present invention, the device of the present invention possesses an interface that shows information related to the characteristics of the liquid in the container (1) and to the use and consumption habits of the liquids in the container (1).

This allows for characterization of the quantities of substances ingested in a given time period, the time it takes to ingest them, and description of the movement used to do so.

In another aspect of the present invention, the electronic container also contains a device that produces sound or vibrates in connection with the signals transmitted by one of the controllers, to inform the user about patterns of the liquid to be drunk or of the movement used to ingest it.

In a preferred version of the present invention, the sensor elements for chemical substances measure the concentration of a group of substances, which includes the following families: sugars, alcohols, alkaloids, halide salts, oxoacid salts, organic acids, aromatic hydrocarbons, derivatives of these chemical families, and mixtures thereof, which are substances commonly found in ingestible liquids. Other sensors, however, can be incorporated into the present invention to detect a multiplicity of chemical substances in addition to those mentioned previously.

In a preferred version of the invention, the previously described sensor for chemical substances can contain, for example, ultraviolet light photometric sensors, to detect colorless substances; visible light photometric sensors, to detect the presence of colored samples; infrared radiation photometric sensors, to characterize and quantify organic chemical substances, such as sugars or proteins; and alternatively, refraction index photometric sensors, for example, to detect translucent substances such as solutions of sugar, alcohols and similar substances.

### Example of One Embodiment of the Present Invention

In one embodiment of the present invention, the device is composed of a cylindrical container (1) to monitor liquid ingestion. The device was built in a cup shape, with a 7 cm diameter and a height of 15 cm.

### Example of an Embodiment of the Invention

Additionally, a color intensity sensor was incorporated, with the characteristics displayed in Table 1.

TABLE 1
Characteristics of the color intensity sensor

Red, Green, Blue LED (RGB) and white light
Sensor with IR blocking filter
Programmable analog gain
I2C communication interface
Data transmission of up to 400 kbit/s
Small package: 2 mm × 2.4 mm

The device was equipped with sensors to measure the color intensity of two different commercial cola beverages, before their ingestion. The invention incorporated a wireless WIFI communication module under the 802.11 standard, in order to wirelessly transmit data obtained by the sensor, a microcontroller to read the data from the sensor, process them and transmit them to the wireless communication module for the purpose of communicating with a web platform hosted on a server in the cloud. In the case of the sensor, it provides digital (in I2C, serial, one wire protocols) or analog information, which is interpreted by the microcontroller by means of an analog-digital converter (ADC) module contained within it.

As a power source for the invention, including the wireless transmission module and the color sensor, two functionally linked AA batteries with a DC/DC boost converter were utilized in order to provide the system with a general power supply voltage of 3.3V.

The environmental conditions (temperature, pressure and ambient light) that were manipulated for capturing color data for both beverages were identical.

The following time-intensity curves obtained as a result show the intensity of the color of the beverage contained in the cup over time, measured in milliseconds.

Color Intensity

As a result of this example, we conclude that both cola beverages possess differences in color intensity, having measured different intensities for the color red in both beverages, by means of which a user could detect these differences before drinking it, or even characterize an unknown type of beverage, using the present invention.

It must be understood that the present invention is not restricted to the modalities described and exemplified herein. As is evident to a person versed in the art, there are other possible variations and modifications that do not deviate from the spirit of the invention, which is only defined by the following claims:

1. A device that provides information about the physical characteristics of its environment, comprising:
a. an electronic system that contains a plurality of sensors that measure at least one physical and/or chemical variable in the device's physical environment;
b. a data processing system that processes data collected by the plurality of sensors; and
c. a communication system that transmits the processed data from the sensors to a data center where the physical variables are determined.

2. The device of claim 1, wherein the electronic system comprises:
a. a sensor device that receives a physical or chemical signal and converts it into an electrical signal;
b. a microcontroller that reads the data transmitted by the sensor, wherein the microcontroller comprises at least: an ADC module, a UART serial communication module, and an I2C communication module;
c. a means for providing power to the elements of the system;
d. a wireless communication module that sends information about the sensed information to a platform hosted on a web server.

3. The device of claim 1, wherein the plurality of sensors comprises a group of sensors of chemical substances, position, trajectory, velocity, acceleration, temperature, color, density, fill level and hydrostatic pressure.

4. The device of claim 1, wherein that the communication system that transmits processed data from the sensors, consists of a protocol selected from the group consisting of: IEEE 802.15.4, Zigbee, 6LowPan, Bluetooth, WiFi, cellular network, Ant+; or wired means of communication with a protocol selected from the group consisting of: USB, stereo plug.

5. The device of claim 1, wherein that the device comprises means to visualize the data processed by the processing system.

6. The device of claim 1, wherein the device comprises energy accumulators to supply electrical power to the device, to the processing system and to embedded electronic devices of the communication system.

7. The device of claim 6, wherein the energy accumulators are selected from the group that consists of: batteries, piezoelectric devices, wireless charging devices, or energy-harvesting devices.

8. The device of claim 1, wherein the plurality of sensors quantify and transmit the data obtained from its readings to the communication system.

9. The device of claim 3, wherein the chemical substance sensors are selected from the group that consists of: ultraviolet light photometric sensors, light photometric sensors, infrared radiation photometric sensors, refraction index photometric sensors.

10. The device of claim 1, wherein the device is a receptacle having an outer surface.

11. The device of claim 1, wherein the device is a container.

12. The device of claim 1, wherein the container has an electronic system, a communication system, and means for data visualization embedded in the container.

13. The device of claim 11, wherein the container further comprises an interface linked to a microcontroller in order to graphically represent the data obtained by the sensors placed in said container.

14. The device of claim 13, wherein the device further comprises means to produce sound or vibration in connection with the signals transmitted by the microcontroller.

15. The device of claim 13 wherein the chemical substance sensors detect presence of liquid in the container and quantify concentration of chemical substances present in said liquid.

16. The device of claim 1, wherein the device has a motion sensor to measure the position, trajectory, velocity and acceleration of said liquid.
